(19) United States
(12) Patent Application Publication
(10) Pub. No.: US 2010/0259673 A1
(43) Pub. Date: Oct. 14, 2010

(54) MOBILE VIDEO EYEWEAR DATA RECEIVING AND TRANSMITTING SYSTEM

(76) Inventor: Shawn R. Russell, Spokane, WA (US)

Correspondence Address: SHAWN RICHARD RUSSELL, 615 E. CASCADE PL., SPOKANE, WA, 99208, US

(21) Appl. No.: 12/423,162

(22) Filed: Apr. 14, 2009

(51) Int. Cl. H04N 9/12

(52) U.S. Cl. 348/383; 348/E09.012

(57) ABSTRACT

A mobile video eyewear data receiving and transmitting system that receives and transmits data that enables users to view data and video content on a large virtual display screen without obstructing vision of the surrounding environment. Data that is received by the mobile video eyewear permits users access to the internet, GPS, email, TV, documents, music videos, video content, virtual reality, video gaming, data transmission, and video cellular communications.

The present invention relates to mobile video eyeglasses and the data that they provide users to allow them to interact with information and their environment in a safe manner. Mobile video eyeglasses that use existing cellular infrastructure and space based satellite transmission that will provide users access to receive and transmit data.

### DRAWINGS

FIG. 1 represents a mobile video eyeglass data system embodiment of the present invention, and is referred to herein by the general reference numeral 100. System 100, in one instance, comprises a mobile video eyeglass data receiver/transmitter 101 located anywhere to receive and transmit data 102 from existing cellular infrastructure 103. and to receive and transmit data 104 from space based satellites 105.

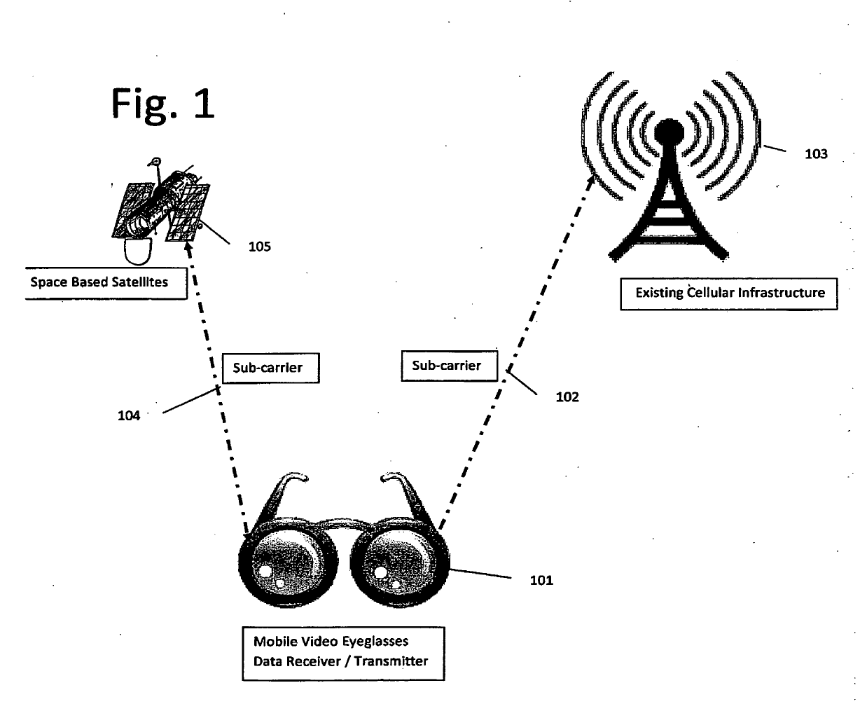

It is therefore an object of the present invention to provide a mobile video eyeglass data system that receives and transmits information enabling users to view data content on a large virtual display screen without obstructing vision of the surrounding environment.

It is still further object of the present invention to receive and transmit data to and from the mobile video eyeglasses using existing cellular infrastructure. and space based satellite transmissions.

1. A mobile video eyewear data receiving and transmitting system, comprising:
a. Mobile receiver/transmitter video eyeglasses for the purpose of receiving/transmitting applications such as TV, videos, music videos, internet, GPS, email, documents, video gaming, virtual reality, and video cellular communications.
b. Mobile video eyeglasses enabling users to view data content on a large virtual display screen without obstructing vision of the surrounding environment.
c. Bluetooth technology to complete the visual experience of the mobile video eyeglasses with sound.

2. A mobile video eyewear data receiving and transmitting system, comprising;
a. Service/subscription service to individual mobile video eyeglass users to receive and transmit data, video communications, and media content.
b. Service/subscription service is accessed through existing cellular infrastructure.
c. Service/subscription service is accessed through space based satellite transmission.
